(19) United States
(12) Patent Application Publication
(10) Pub. No.: US 2026/0212428 A1
(43) Pub. Date: Jul. 23, 2026

(54) FEDERATED LEARNING AND BLOCKCHAIN ASSISTED PEER-TO-PEER ENERGY PLATFORM

(71) Applicants: MOHAMED BIN ZAYED UNIVERSITY OF ARTIFICIAL INTELLIGENCE, Abu Dhabi (AE); ZAYED UNIVERSITY, Dubai (AE); AL AIN UNIVERSITY, Al Ain (AE); KOC UNIVERSITY, Sariyer/Istanbul (TR)

(72) Inventors: Ouns BOUCHIR, Dubai (AE); Moayad ALOQAILY, Abu Dhabi (AE); Faizan ALI, Istanbul (TR); Oeznur OEZKASAP, Sariyer/Istanbul (TR)

(73) Assignees: MOHAMED BIN ZAYED UNIVERSITY OF ARTIFICIAL INTELLIGENCE, Abu Dhabi (AE); ZAYED UNIVERSITY, Dubai (AE); AL AIN UNIVERSITY, Al Ain (AE); KOC UNIVERSITY, Sariyer/Istanbul (TR)

(21) Appl. No.: 19/142,312

(22) PCT Filed: Dec. 29, 2022
(86) PCT No.: PCT/IB2022/000787

§ 371 Date: Jun. 23, 2025

(51) Int. Cl. G06Q 50/06; G06N 20/00; H02J 3/008

(52) U.S. Cl. CPC G06Q 50/06; G06N 20/00; H02J 3/008; G06Q 2220/00

(57) ABSTRACT

A method and system for electrical energy transfer and allocation that includes a blockchain systems for identifying and tracking energy demands and requests by geographical and coordinates and other characteristics through a usage and/or consumption chain that includes consumers and producers (prosumers). A microgrid identifier can be used to tag a consumer and relate the consumer to a producer by geography or demand. Based on demand and location data an energy factor can be calculated and thereby serve to match consumers and producers. A federated learning model can be used to accommodate an energy sharing stage on the blockchain and thereby facilitate, by a server computer, the transport of excess available energy from one energy producer in a first microgrid to either an energy consumer in the first microgrid or an energy storage unit of a second microgrid.

### STATEMENT REGARDING PRIOR DISCLOSURE BY THE INVENTORS

Aspects of the present disclosure are described in O. Bouachir, M. Aloqaily, Ö. Özkasap and F. Ali, “FederatedGrids: Federated Learning and Blockchain-Assisted P2P Energy Sharing,” in IEEE Transactions on Green Communications and Networking, vol. 6, no. 1, pp. 424-436, March 2022, doi: 10.1109/TGCN.2022.3140978 which is incorporated here by reference in its entirety.

### BACKGROUND

### Field of the Invention

The present disclosure relates to a system and method for transferring energy between a production point and a usage point. In one aspect the efficiency of energy transfer is improved using a federated learning model.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

In recent years, the demand for energy rapidly increased due in part due to population increases and modernization. However, although the demand for energy is constantly growing, the supply of energy has been nearly constant. To combat the increased demand, peer-to-peer (P2P) energy trading platforms have been developed. P2P energy trading allows for energy consumers (e.g., vehicles, houses, corporate buildings, etc.) to act both as an energy prosumer as well as an energy consumer. In particular, energy consumers can produce electricity using conventional or renewable energy sources (e.g., solar, wind, etc.) to satisfy their personal energy demand and sell any excess energy to other energy consumers, or to a main electrical grid. P2P energy trading platforms rely on the participation of prosumers and consumers to create a dynamic market for energy trading. Thus, features of the platform should encourage participation and provide availability to both energy prosumers and energy consumers.

P2P energy trading platforms are designed to provide a balanced solution for energy trading to all participating energy prosumers, consumers, and the main utility grid. The balance is in part provided by the two competing factors of the stable coverage of energy demand of energy consumers and profit maximization for energy prosumers. This balance is however not stable. High energy costs are in party due to expenses burdened by energy prosumers related to the storage and management of excess energy. This along with other factors can drive the price of energy up and in many cases causes some energy consumers to be unable to purchase energy on the platform. Many of such problems are exacerbated in smaller geographic locations in which there is lack of diversified energy prosumers and consumers.

Implementations of P2P energy trading platforms face additional challenges in protecting the security and privacy of registered energy prosumers and consumers. Performing the energy transaction (i.e., a transaction that combines a financial transaction and a subsequent physical transport of electrical energy), privacy of sensitive data, and guarantee of energy transport are some of the issues that P2P energy trading platforms face.

Previous implementations of P2P energy trading platforms suffer from one or more drawbacks hindering their adoption. Notably, implementations of P2P energy trading platforms do not provide accessibility of energy to energy consumers with a lack of funds to purchase energy on the market. In addition, energy prosumers are burdened with the need to store excess energy that they do not trade which can be costly and inefficient. Accordingly, it is one object of the present disclosure to provide methods and systems for energy trading and sharing through a P2P energy trading platform.

### SUMMARY

In an exemplary embodiment, an electrical energy transfer method is facilitated by a server computer. The method includes deploying, by the server computer, one or more smart contracts to a blockchain. The method then includes receiving, by the server computer from each of a plurality of energy consumer computers, an energy consumer registration request comprising a consumer geographic location indicator. Each of the plurality of energy consumer computers is operated by an energy consumer associated with the geographic location indicated by the consumer geographic location indicator. The method then includes receiving an energy consumer registration request, and in response, registering the energy consumer to the blockchain. As a part of the registration, the energy consumer can be given a microgrid identifier that identifies a microgrid that the energy consumer geographic location is proximate to. The method then includes receiving, by the server computer from each of a plurality of energy prosumer computers, an energy prosumer registration request comprising a prosumer geographic location indicator and an available energy amount. Each of the plurality of energy prosumer computers is operated by an energy prosumer associated with the geographic location indicated by the prosumer geographic location indicator. The method then includes receiving an energy prosumer registration request, and in response, registering the energy prosumer to the blockchain. As a part of the registration, the energy prosumer can be given a microgrid identifier that identifies a microgrid that the energy prosumer geographic location is proximate to. The method additionally includes initiating, by the server computer, an energy trading stage on the blockchain. The server computer can then receive, from one or more of the plurality of energy prosumer computers, a prosumer trading participation request comprising the prosumer geographic location indicator and the available energy amount of the energy prosumer. The server computer can additionally receive, from one or more of the plurality of consumer energy computers, a consumer trading participation request comprising the consumer geographic location indicator and a requested energy amount of the energy consumer. For each microgrid of the plurality of microgrids, the server computer can compute an energy price for trading between the current microgrid and each of the other microgrids in the plurality of microgrids and then facilitate the consumer trading participation requests received from energy consumers in the microgrid using the blockchain. The method then includes computing next-stage energy statistics using a federated learning model distributed to one or more energy consumer computers or energy prosumer computers. The server computer can then initiate an energy sharing stage on the blockchain. The method can then include facilitating the transport of excess available energy from one energy prosumer in a first microgrid to either an energy consumer in the first microgrid or an energy storage unit of a second microgrid.

In another exemplary embodiment, a method includes transmitting, by an energy consumer computer via a smart contract deployed on a blockchain, an energy consumer registration request comprising a geographic location indicator and a request type to the blockchain, wherein the blockchain is operated by a server computer. The method also includes transmitting, by the energy consumer computer to the blockchain, a consumer participation request comprising a requested energy amount, wherein the blockchain thereafter facilitates completion of the consumer participation request. The method then includes receiving, by the energy consumer computer from the blockchain, an energy transfer notification message and storing, by the energy consumer computer, local data of the blockchain.

In another exemplary embodiment, a non-transitory computer readable medium having instructions stored therein that, when executed by one or more processors, cause the one or more processors to perform a method of deploying one or more smart contracts to a blockchain; receiving, from each of a plurality of energy consumer computers, an energy consumer registration request comprising a consumer geographic location indicator, wherein each of the plurality of energy consumer computers is operated by an energy consumer associated with the geographic location indicated by the consumer geographic location indicator; responsive to receiving an energy consumer registration request, registering, the energy consumer to the blockchain, wherein the energy consumer is given a microgrid identifier that identifies a microgrid that the energy consumer geographic location is proximate to; receiving, from each of a plurality of energy prosumer computers, an energy prosumer registration request comprising a prosumer geographic location indicator and an available energy amount, wherein each of the plurality of energy prosumer computers is operated by an energy prosumer associated with the geographic location indicated by the prosumer geographic location indicator; responsive to receiving an energy prosumer registration request, registering, the energy prosumer to the blockchain, wherein the energy prosumer is given a microgrid identifier that identifies a microgrid that the energy prosumer geographic location is proximate to; initiating an energy trading stage on the blockchain; receiving, from one or more of the plurality of energy prosumer computers, a prosumer trading participation request comprising the prosumer geographic location indicator and the available energy amount of the energy prosumer; receiving, from one or more of the plurality of consumer energy computers, a consumer trading participation request comprising the consumer geographic location indicator and a requested energy amount of the energy consumer; for each microgrid of the plurality of microgrids: computing an energy price for trading between the current microgrid and each of the other microgrids in the plurality of microgrids; facilitating the consumer trading participation requests received from energy consumers in the microgrid using the blockchain; computing next-stage energy statistics using a federated learning model distributed to one or more energy consumer computers or energy prosumer computers; initiating an energy sharing stage on the blockchain; and facilitating the transport of excess available energy from one energy prosumer in a first microgrid to either an energy consumer in the first microgrid or an energy storage unit of a second microgrid.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is an exemplary illustration of an energy transport system according to certain embodiments.

FIG. 2 is an exemplary illustration of phases of an energy transport method according to certain embodiments.

FIG. 3 is an exemplary block diagram of an energy exchange through various smart contracts according to certain embodiments.

FIG. 4 is exemplary pseudocode of an energy request processing algorithm according to certain embodiments.

FIG. 5 is exemplary pseudocode of a blockchain federated calculation algorithm according to certain embodiments.

FIG. 6 is an exemplary graph of predicted energy load per hour according to certain embodiments.

FIG. 7 is an exemplary graph of training loss vs. validation loss according to certain embodiments.

FIG. 8 is an exemplary graph of total network gain achieved according to certain embodiments.

FIG. 9 is an exemplary graph of energy generation of five microgrids according to certain embodiments.

FIG. 10 is an exemplary graph of completed energy share requests according to certain embodiments.

FIG. 11 is an exemplary graph of energy shared within a microgrid and energy shared across microgrids according to certain embodiments.

FIG. 12 is an exemplary graph of energy shared and traded by each of five microgrids according to certain embodiments.

FIG. 13 is an exemplary graph of kilowatt-hours of energy shared by energy prosumers within a microgrid and between microgrids according to certain embodiments.

FIG. 14 is an exemplary graph of kilowatt-hours of energy traded and shared by per prosumer in a microgrid according to certain embodiments.

FIG. 15 is an illustration of a non-limiting example of details of computing hardware used in the computing system, according to certain embodiments.

FIG. 16 is an exemplary schematic diagram of a data processing system used within the computing system, according to certain embodiments.

FIG. 17 is an exemplary schematic diagram of a processor used with the computing system, according to certain embodiments.

FIG. 18 is an illustration of a non-limiting example of distributed components which may share processing with the controller, according to certain embodiments.

FIG. 19 is an exemplary flowchart for an electrical energy transfer method, according to certain embodiments.

FIG. 20 is an exemplary flowchart for another electrical energy transfer method, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system, device, and method for the transfer, trading and/or sharing of electrical energy. Embodiments provide for a peer-to-peer (P2P) energy transfer, trading and/or sharing platform using blockchain technologies and federated learning. The use of a peer-to-peer (P2P) energy transfer, trading and/or sharing platform allows users of the platform to securely transport energy between themselves, or to a main utility grid. Several smart contracts and their associated functions are deployed to a blockchain to facilitate energy transport from energy prosumers to energy consumers.

Embodiments provide for a number of advantages. Embodiments provide for a blockchain-based peer-to-peer energy trading and sharing, allowing users to transfer/buy/sell energy from/to peers inside a microgrid and between different microgrids, providing an algorithm and/or pricing mechanism that ensures an increase in utility. In particular, embodiments provide for an energy transfer and/or sharing phase in which energy prosumers can choose to transfer and/or share excess energy with energy consumers for both immediate (e.g., reduction in costs of storage of excess energy) and future benefits (e.g., credit value, energy cost discounts, etc.). Embodiments employ a federated learning-based model to provide for accurate predictions of the next stage energy production and system load. These predications can be used to make decisions related to the amount of energy that can be transfer and/or shared in the sharing phase. Embodiments implement the P2P energy transfer, trading and/or sharing platform using blockchain technology. Blockchain provides for an autonomous system based on smart contracts, and their associated functions, that are deployed on the blockchain. The smart contracts implement the various rules of energy sharing and trading within the platform and allow users to perform energy transactions.

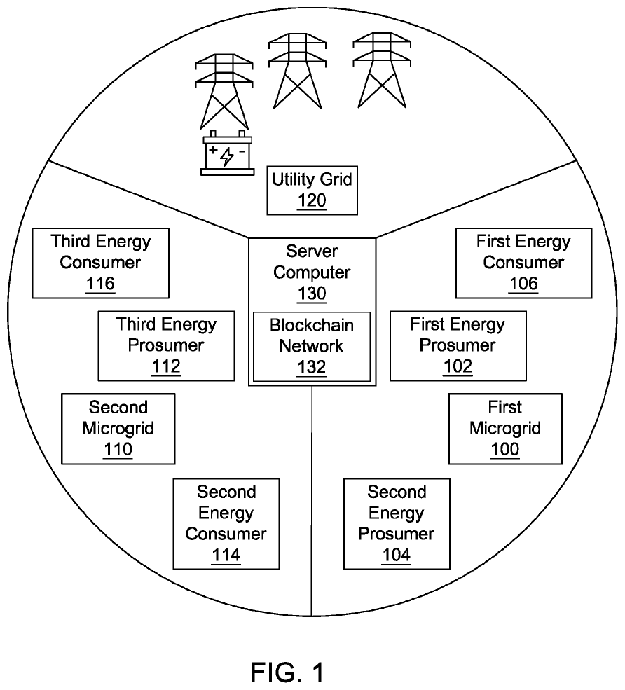

FIG. 1 is an exemplary illustration of an energy transport system according to certain embodiments. The energy transport system includes a first microgrid 100, a second microgrid 110, a utility grid 120, and a server computer 130.

The first microgrid 100 includes a first energy prosumer 102, a second energy prosumer 104, and a first energy consumer 106. An example of the first energy prosumer 102 can include any entity capable of consuming and producing electrical energy, such as a house equipped with a renewable energy source (e.g., a house equipped with a solar panel roof), an office building with a gas generator, a wind turbine farm, etc. The first energy prosumer 102 can have a smart energy management system that allows monitoring of energy consumption, production, trading, and sharing. The second energy prosumer 104 can be similar to the first energy prosumer 102. The first energy consumer 106 can include any entity that is capable of consuming electrical energy, such as a home, apartment building, electric vehicle, etc. The second microgrid 110 can similarly include a third energy prosumer 112, a second energy consumer 114, and a third energy consumer 116. In some embodiments, each energy prosumer can be associated with an energy prosumer computer that can be used to communicate with the server computer 130, and with a prosumer geographic location (e.g., the location of the energy prosumer's house). Similarly, each energy consumer can be associated with an energy consumer computer and a consumer geographic location.

The utility grid 120 can include energy generation facilities (e.g., gas-, oil-, or coal-based generators, hydro-electric generators, solar panel farms, wind turbines, nuclear power plants, etc.), energy transmission facilities (e.g., transformers, high voltage transmission lines), and energy distribution facilities (e.g., substations, power lines, etc.). The utility grid 120 can be a conventional power system that generates electric energy at an energy generation facility, increases the voltage using a transformer to transmit the energy through high voltage transmission lines, decreases the voltage using a transformer to transmits energy to a substation which then routes the electrical energy to energy consumers. The utility grid 120 can additionally include energy stores such as batteries, capacitors, or any other suitable device for storage of electrical energy. The utility grid 120 can be controlled, maintained, and monitored using a central computer that handles energy transportation.

The server computer 130 can manage and operate a blockchain network 132. The blockchain network 132 can be a distributed network that is distributed across one or more blockchain node computers. Examples of blockchain technologies can be found in M. Crosby, et al., “BlockChain Technology: Beyond Bitcoin,” in Sutardja Center for Entrepreneurship & Technology Technical Report, Oct. 16, 2015, incorporated herein by reference with regard to the disclosed blockchain technologies.

The first microgrid 100 and the second microgrid 110 can be the collection of all energy prosumers, energy consumers, and distributed energy resources with electrical wires within a given geographic area. The first microgrid 100 and the second microgrid 110 can be connected through the utility grid 120.

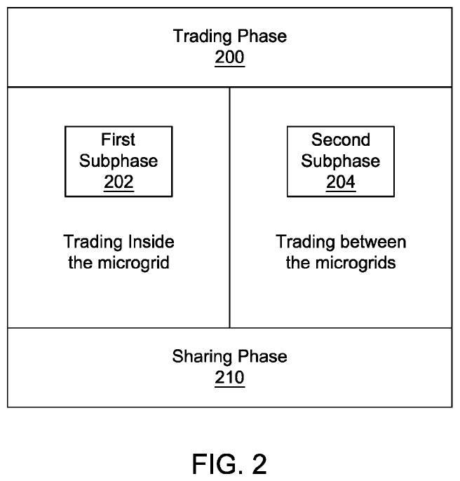

Embodiments provide for a P2P energy trading and sharing platform in which energy prosumers and energy consumers trade and share energy. An example of trading within a microgrid can include the first energy prosumer 102 trading energy with the first energy consumer 106. An example of trading outside of the microgrid can include the second energy prosumer 104 trading energy with the second energy consumer 112. An example of sharing energy can include the first energy prosumer 102 sharing excess energy with the second energy prosumer 104. Another example of sharing energy can include the first microgrid 110 sharing excess energy from the first energy prosumer 104 to the third energy consumer 116 of the second microgrid 120. An illustration and overview of the trading and sharing phases initiated by the P2P energy trading and sharing platform can be described with reference to FIG. 2.

FIG. 2 is an exemplary illustration of phases of an energy transport method according to certain embodiments. The energy transport method comprises a trading phase 200 and a sharing phase 210. The server computer 130 of FIG. 1 can initiate the trading phase 200 on the blockchain network 142. Energy consumers may transmit consumer trading participation requests to the server computer 130 or to a blockchain node computer. The consumer trading participation request can comprise a requested energy amount and can indicate that the consumer wishes to purchase energy. Similarly, energy prosumers can transmit prosumer trading participation requests, comprising an available energy amount, indicating that the prosumer wishes to sell energy. The trading phase 200 can further comprise a first subphase 202 and a second subphase 204.

In the first subphase 202, trading within the microgrid can performed to cover the local energy demand. The above example of the first energy prosumer 102 trading energy with the first energy consumer 106 is an example energy trade that can occur during this phase. The first subphase 202 can reach one of three conclusions. A first option can be reached if the energy produced by the energy prosumers of the microgrid is equal to the local demand, then all local energy demands of the microgrid are fulfilled (e.g., all consumer trading participation requests are fulfilled). A second option can be reached if the energy produced by the energy prosumers of the microgrid is less than the local demand. All the excess energy is traded within the microgrid, however, some energy requests of energy consumers in the microgrid are still active. A third option can be reached if the energy produced by the energy prosumers of the microgrid is greater than the local demand. All of the local energy requests are fulfilled, however, energy prosumers still have a surplus of energy. If the third option is reached, energy prosumers have a choice to 1) sell their excess energy to the utility grid 120, or 2) sell their excess energy to outside microgrids.

As a result of the second option or third options being reached, the second subphase 204 can be initiated. In the second subphase 204, trading between microgrids can be performed, such as the above example of the second energy prosumer 104 trading energy with the second energy consumer 112. Optionally, the second microgrid 110 can instead communicate with the utility grid 120 to cover the local energy demand as is done in traditional power systems. However, energy supplied by the utility grid 120 is likely to have higher cost than the energy supplied by an external microgrid. Indeed, due to transport, storage, and other costs, it is preferable that the costs of obtaining energy from within a microgrid is less than the costs of obtaining energy outside of the microgrid, which should be less yet than the costs of obtaining energy from the utility grid.

In embodiment, the cost of energy for trading within the microgrid, transfer and/or trading outside of the microgrid, and transfer and/or trading with the utility grid are determined at the beginning of the trading phase 200. The cost of energy is reliant upon several factors, including the total energy demand in the microgrid, the total production of energy in the microgrid, and the type of renewable energy source used by the energy prosumer. The cost of energy for trading outside of the microgrid additionally includes factors of distance, and the utility grid infrastructure used to transport energy between the two microgrids. In general, this can be summarized by the following equation:

$${P}_{P 2 P} \leq {P}_{P 2 M} \leq {P}_{P 2 U}$$

Where P_{P2P} represents the cost of trading energy within a microgrid, P_{P2M} represents the cost of transfer and/or trading energy from one microgrid to a second microgrid, and PPzu represents the cost of transfer and/or trading energy from a utility grid.

After the trading phase 200 has concluded, the sharing phase 210 can be initiated. Two types of energy sharing can occur during the sharing phase 210. The first is energy sharing between prosumers and consumers. In some situations, this can occur if an energy consumer did not have funds to participate in the trading phase 200 or was otherwise unable to participate. The energy consumer can transmit a consumer sharing participation request to the server computer 130 to indicate they are requesting an amount of shared energy. In one example, the second energy consumer 114 can transmit a consumer sharing participation request to the server computer 130. The request can be fulfilled by the first energy prosumer 102 sharing excess energy equal to the requested shared energy amount with the second energy consumer 114.

The second energy sharing type is energy resource sharing. Microgrids include multiple entities, some of which may have their own energy storage while some others may have renewable energy sources and yet others may have both. If the energy load of one energy prosumer increases, the renewable energy source or the storage capacity may increase. Both solutions are considered costly since they can require infrastructure modification at the expense of the energy prosumer. This prosumer can instead share storage with a central microgrid energy store or with the energy stores of others in the microgrid. An example of energy resource sharing can include the first energy prosumer 102 transporting excess available energy to an energy store of the first energy consumer 106. The energy can be returned to the energy prosumer before the next trading phase, or to a purchasing energy consumer in the next trading phase.

In some embodiments, the server computer 130 can profit benefits to participants of the sharing phase 110. For example, the server computer 130 can provide high privileges to sell and purchase energy for energy prosumers that participated in the sharing phase 120.

The P2P energy trading and sharing platform can be implemented using a blockchain. The server computer 130 of FIG. 1 can maintain the blockchain network 132 that acts as the P2P energy trading and sharing platform. The blockchain can handle all energy trading and sharing transfers between the energy prosumers and consumers inside a microgrid, between various microgrids, and with the utility grid. In addition, blockchain allows the storage of all information related to the different entities: prosumers, consumers, utility grids, and microgrids. The server computer 130 can implement the rules of the platform by deploying several smart contracts to the blockchain.

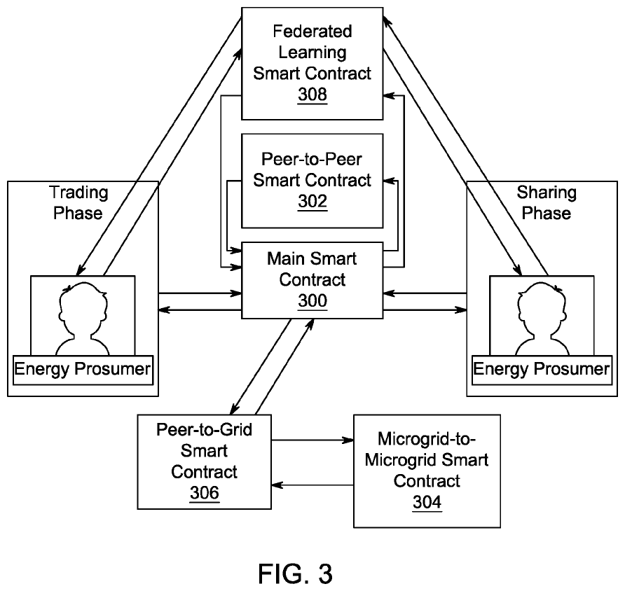

FIG. 3 is an exemplary block diagram of an energy exchange through various smart contracts according to certain embodiments. The server computer 130 can deploy a main smart contract 300, a peer-to-peer smart contract 302, a microgrid-to-microgrid smart contract 304, a peer-to-grid smart contract 306, and a federated learning smart contract 308 to the blockchain. A “smart contract” can be a digital agreement. Smart contracts are typically computer programs or a collection of functions that are used to automate the completion of an agreement between two parties without the need for an intermediary. A smart contract can comprise one or more functions that are automatically executed when predetermined conditions are met. For example, an identification smart contract can receive an identification number as input. The smart contract can execute a function that resolves the identification number into a name of an individual by searching a database. In embodiments, smart contracts can be deployed to a blockchain, such that users of the blockchain can make use of the smart contract. In one embodiment a smart contract is disposed in memory of a smart device, e.g., a smart card, chip card, or integrated circuit card (ICC or IC card) functioning as a physical electronic authentication device, preferably in the form of a plastic credit card-sized card with an embedded integrated circuit (IC) chip and optionally having a pattern of metal contacts to electrically connect to an internal chip. In this form the smart contract may be contactless or contact. The use of the smart contracts helps to ensure a transparent energy transfer, trading and/or sharing platform, where all participants can trust the smart contracts which eliminates the requirement of central parties to control energy management. In other embodiments, the smart contracts can be deployed on a private blockchain, which allows for a limited number of participants providing for less probability of a cyberattack.

The main smart contract 300 can monitor all operations of energy trading and sharing of the platform. All users can communicate directly with the as it has a key role in energy trading and sharing mechanisms. It enables several key tasks including registering users to the energy blockchain, facilitating participation requests of the energy trading phase and the energy sharing phase, and computation of next-stage energy statistics.

Before generating any participation requests, all energy prosumers and consumers should be registered to the blockchain. Registering the various users (energy consumers and prosumers) and microgrids can include receiving a registration request. An energy consumer can transmit an energy consumer registration request by calling the registration function with a consumer geographic location indicator (e.g., a street address of the consumer geographic location). As a response to receiving the registration request, the energy consumer can be registered to the blockchain. The registration of the energy consumer can comprise generating a unique consumer identifier for the energy consumer, and assigning a microgrid identifier to the energy consumer by identifying a microgrid that the consumer geographic location is proximate to. Registration can additional include storing the unique consumer identifier, the geographic location indicator, and the microgrid identifier. Similarly, the registration of the energy prosumers can comprise receiving an energy prosumer registration request comprising a prosumer geographic location and an available energy amount. Responsive to receiving the prosumer registration request, a microgrid identifier can be assigned to the energy prosumer by identifying a microgrid that the prosumer geographic location is proximate to, and generating a unique prosumer identifier for the energy prosumer and storing the unique prosumer identifier, the geographic location indicator of the energy prosumer, the available energy amount, and the microgrid identifier of the energy prosumer. After registration is complete, participants will be able to send their participation requests that are handled through the main smart contract 300.

The main smart contract 300 can additionally be used to facilitate participation requests of the energy trading phase and the energy sharing phase. The main smart contract 300 can determine a list of energy prosumers that can match with energy consumers within and across the microgrids for energy trading and sharing. For each consumer participation request received, the main smart contract 300 can call the functions of the peer-to-peer smart contract 302 to that match the energy consumer with local energy prosumers. When the local demand exceeds the available local energy (e.g., the third option described in the description of FIG. 2), the main smart contract 300 can call the functions of the microgrid-to-microgrid smart contract 304 to find a microgrid with surplus energy for energy trade. In the case that there is no surplus energy in any microgrid to cover the needs, it can contact the utility grid to buy the energy. In the case of the energy sharing requests, the main smart contract 300 can check if the sharing phase is enabled. The uses the same matching mechanism as the trading phase can then be used.

The main smart contract 300 can also be used to perform the computation of next-stage energy statistics. The next-stage energy statistics can include a predicted energy generation of energy prosumers in each microgrid of the plurality of microgrids, a predicted energy load of each individual energy consumer in each microgrid of the plurality of microgrids, a predicted amount of energy transferred in the next energy trading stage and the next energy sharing stage, and a predicted cost of energy in the next energy trading stage. To perform these computations, the main smart contract 300 can call the functions of the federated learning smart contract 308.

The peer-to-peer smart contract 302 maintains the information of the energy prosumers and consumers when they register through the main smart contract 300. Only the main smart contract 300 can invoke the peer-to-peer smart contract 302. A function of the peer-to-peer smart contract 302 can be called by the main smart contract 300 using an energy consumer identifier and allows checking the microgrid identifier of the energy consumer and retrieves the list of energy prosumers that can cover the requested energy amount of the energy consumer.

The microgrid-to-microgrid smart contract 304 maintains all the microgrids' information. In some embodiments, the information can be stored in a dictionary-like data structure called “maps”. The microgrid-to-microgrid smart contract 304 is used to facilitate the exchange of energy between microgrids. Only the main smart contract 300 can invoke the microgrid-to-microgrid smart contract 304. A function of the microgrid-to-microgrid smart contract 304 can be called to find a suitable microgrid that is able fulfill the energy demand of an energy consumer another microgrid.

The peer-to-grid smart contract 306 can be used by energy consumers to buy energy from utility grids, or but energy prosumers to sell energy to the utility grids. As such, all users can directly access this smart contract. The peer-to-grid smart contract 306 can be deployed to the blockchain by the server computer or by the utility grid.

The federated learning smart contract 308 can, in conjunction with a federated learning model, allows the server computer to select various users for the coming round of next-stage energy statistics computations. The federated learning smart contract 308 can also be used to share and gather the federated learning model to and from the selected users and perform aggregation at the end of each round. It uses three different functions: a first function to gather federated learning model parameters from the main smart contract 300, a second function for the selected users to receive the federated learning model, and a third function to allow the selected users to send the updated parameters.

The smart contracts can be used transmit a participation request and facilitate the request. After a user is registered, they may act as an energy consumer, and use the main contract to transmit the consumer participation request.

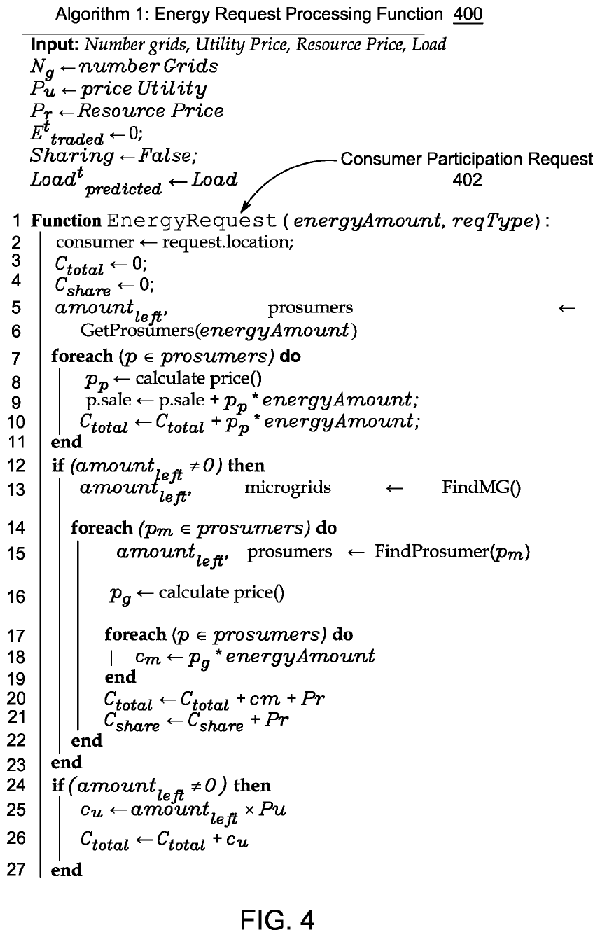

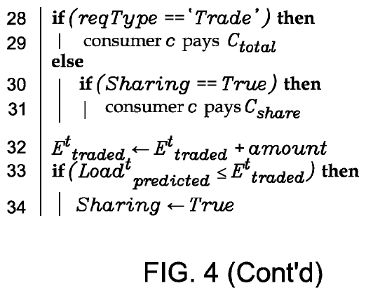

FIG. 4 is exemplary pseudocode of an energy request processing algorithm 400 according to certain embodiments. The energy request processing algorithm 400 can be initialized by inputting the total number of microgrids Ng, retrieving a utility grid energy rate Pu, retrieving an energy resource cost for common resources Pr, setting a total energy transported amount Etraded of zero, setting a sharing variable to False, and retrieving an energy load prediction. A consumer participation request 402 can be received by the energy request processing algorithm 400. The consumer participation request 402 can be transmitted by an energy consumer with an energy amount and a request type (i.e., consumer trading participation request or consumer sharing participation request) as input.

At line 1 of the consumer participation request 402, the function can be called by an energy consumer with an energy amount and a request type. For example, an energy consumer can submit a consumer participation request for 1000 kWh. In some embodiments, the unique consumer identifier may be transmitted with the consumer participation request and all further requests.

At line 2 of the consumer participation request 402, the geographic location of the energy consumer is retrieved from storage. For example, the unique consumer identifier can be used to query a database for the geographic location identifier of the energy consumer.

At line 3 of the consumer participation request 402, the total cost amount of the energy consumer is set to zero. The total cost amount can be a variable that holds the total cost of all energy transfers performed by the energy consumer during the current stage.

At line 4 of the consumer participation request 402, the share cost amount of the energy consumer is set to zero. The share cost amount is used if the type of request is a “sharing” request. In “trading” requests, the energy consumer would pay the total cost amount which includes the price of the requested energy amount. However, in “sharing” requests, the energy consumer would pay the shar cost amount of the remaining energy, which only includes the resource cost.

At line 5 of the consumer participation request 402, a remaining requested energy amount is set as equal to the requested energy amount. The remaining requested energy amount can be used to track the remaining amount of energy that the energy consumer has yet to obtain from the total requested energy amount.

At line 6 of the consumer participation request 402, a list of prosumers is populated with energy prosumers from all microgrids that have an available energy amount sufficient to cover the requested energy amount. For example, if the energy consumer submitted the energy trading request for 1000 kWh, the list of prosumers would be populated with energy prosumers that have an available energy amount greater than 1000 kWh.

At line 7 of the consumer participation request 402, a loop is initiated to parse through each energy prosumer in the list of prosumers. The loop continues until each energy prosumer in the list of prosumers is parsed through. After each iteration of the loop, the remaining requested energy amount is updated by subtracting the amount of energy that is purchased during that iteration. For example, during a first iteration of the loop, the energy consumer may purchase 350 kWh from a first energy prosumer. The remaining requested energy amount is then updated to equal to 1000−350=650 kWh.

At line 8 of the consumer participation request 402, an energy trading rate for the current energy prosumer is retrieved. For example, during a first iteration of the loop, a first energy consumer may charge 1 cent per kWh which can be stored in the variable pp. In the second iteration of the loop, a second energy consumer may charge 1.5 cents per kWh which can be stored in the variable pp.

At line 9 of the consumer participation request 402, the sale price of the requested energy amount for the current energy prosumer is computer. The sale price of the requested energy amount is computed using the energy trading rate and the requested energy amount (e.g., cost of energy * requested energy amount) in addition to other flat fees such as transaction processing fees or energy transport fees. For example, for the first energy prosumer, the sale price of the requested energy amount would be equal to 10 dollars and would be stored in the variable psale.

At line 10 of the consumer participation request 402, the energy consumer's total cost value is updated include the price of the requested energy amount.

At line 11 of the consumer participation request 402, after each energy prosumer in the list of prosumers is looped through, the loop is broken.

At line 12 of the consumer participation request 402, a primary loop is initiated to check if the remaining requested energy amount is non-zero.

At line 13 of the consumer participation request 402, a list of microgrids that have a total available energy amount greater than the remaining requested energy amount is populated.

At line 14 of the consumer participation request 402, a secondary loop is initiated to parse through each energy prosumer of each microgrid of the list of microgrids. For example, if the first microgrid has two energy prosumers and a second microgrid has five energy prosumers, the loop will parse through the two energy prosumers during a first iteration, and then will parse through the five energy prosumers during a second iteration.

At line 15 of the consumer participation request 402, a list of energy prosumers from the current microgrid that have an available energy amount greater than the remaining request energy amount is populated. For example, during the second iteration of the loop (for the example above, the second iteration corresponds to a second microgrid with five energy prosumers), the first and second energy prosumers may have sufficient available energy while the other energy prosumers do not.

At line 16 of the consumer participation request 402, the cross-microgrid energy trading rate is retrieved. The cross-microgrid energy trading rate can be different than the inner-microgrid trading rate. As previously described, the cost of energy transportation, amongst other factors, means that trading energy to different microgrids will be more costly than trading energy from within a microgrid.

At line 17 of the consumer participation request 402, a tertiary loop is initiated to parse through each energy prosumer in the list of energy prosumers from the current microgrid that have an available energy amount greater than the remaining request energy amount. After each iteration of the tertiary-loop, the remaining requested energy amount is updated by subtracting the amount of energy that is purchased during that iteration. For example, if the energy consumer has a remaining requested energy amount of 650 kWh during a first iteration of the tertiary-loop, the energy consumer may purchase 550 kWh from a first energy prosumer. The remaining requested energy amount is then updated to equal to 650−550=100 kWh before the second iteration is started.

At line 18 of the consumer participation request 402, a cross-microgrid cost of energy is computed using the cross-microgrid energy trading rate and the requested amount remaining.

At line 19 of the consumer participation request 402, the tertiary loop is broken.

At line 20 of the consumer participation request 402, the total cost amount is updated to include the cross-microgrid cost of energy and the resource price.

At line 21 of the consumer participation request 402, the share cost amount is updated to include the resource price.

At line 22 of the consumer participation request 402, the secondary loop is broken.

At line 23 of the consumer participation request 402, the primary loop is broken.

At line 24 of the consumer participation request 402, a loop is initiated to check if the remaining requested energy amount is non-zero.

At line 25 of the consumer participation request 402, a utility cost of energy is computed using the remaining requested energy amount and the utility grid energy rate.

At line 26 of the consumer participation request 402, the total cost amount is updated to include the utility grid cost of energy.

At line 27 of the consumer participation request 402, the loop is broken.

At line 28 of the consumer participation request 402, the type of energy request is checked to determine if it is a “trading” type request (e.g., a consumer trading participation request).

At line 29 of the consumer participation request 402, if the consumer participation request 402 is a “trading” type, then the energy consumer is instructed to pay the total cost amount. The total cost amount includes the resource price, inner-microgrid cost, outer-microgrid cost, and utility grid cost. For example, the server computer 130 can transmit an energy transfer notification message to the energy consumer computer that indicates the energy transfer can be completed upon completion of a financial transaction between the energy consumer and any relevant energy prosumers.

At line 30 of the consumer participation request 402, the type of energy request is checked to determine if it is a “sharing” type request (e.g., a consumer sharing participation request).

At line 31 of the consumer participation request 402, if the consumer participation request 402 is a “sharing” type, then the energy consumer is instructed to pay the share cost amount. The share cost amount only includes the resource price. For example, the server computer 130 can transmit an energy transfer notification message to the energy consumer computer that indicates the energy transfer can be completed upon completion of a financial transaction between the energy consumer and any relevant energy prosumers.

At line 32 of the consumer participation request 402, the total energy transported amount is updated to include the requested energy amount subtracted by the remaining requested energy amount.

At line 33 of the consumer participation request 402, an inequality is checked to determine if the predicted energy load is less than the total energy transported amount.

At line 34 of the consumer participation request 402, if the predicted load is less than the total energy transported amount, then the sharing variable is set to true, and consumer sharing participation requests are allowed to be accepted.

After the consumer participation request 402 is complete, the data accessed during the participation request 402 can be stored by the energy consumer computer. The data can be stored locally in the memory of the energy consumer computer, or on a cloud-based service. Such data can be used in federated learning to individually update a federated learning model. In addition, energy prosumer computers can access similar data when they transmit a prosumer participation request to the blockchain. Both energy consumer computers and energy prosumer computers can store their geographic location, available/requested energy, and microgrid information (including the information of other energy prosumers and consumers of the microgrid).

To better optimize the energy request processing algorithm 400, a set of next-stage energy statistics is computed. The next-stage energy statistics include a predicted energy generation of energy prosumers in each microgrid of the plurality of microgrids, a predicted energy load of each individual energy consumer in each microgrid of the plurality of microgrids, a predicted amount of energy transferred in the next energy trading stage and the next energy sharing stage, and a predicted cost of energy in the next energy trading stage. To generate these predictions, a federated learning model is used.

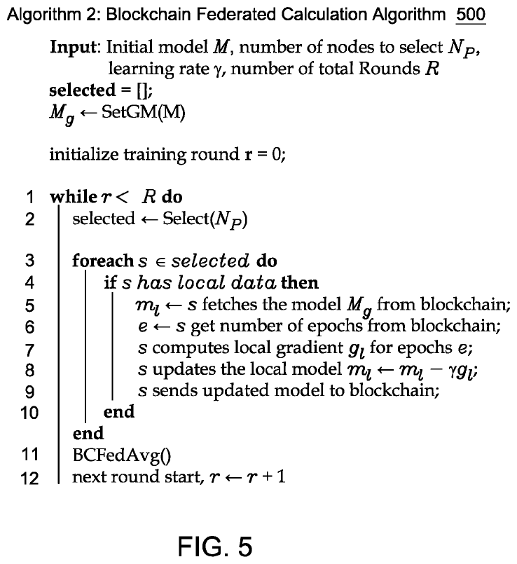

FIG. 5 is exemplary pseudocode of a blockchain federated calculation algorithm 500 according to certain embodiments. The sharing mechanism of the energy request processing algorithm 400 makes use of a prediction of energy load and energy generation for all of the energy prosumers and consumer. Such predictions allow prosumers to take a crucial decision related to their participation in the sharing process. Indeed, if the predictions show a decrease in the energy production level with an increase in the system demand, the prosumer is encouraged to save the available amount of energy for the next trading stage. On the other hand, if the predictions show an increase in the energy production for the coming trading stage that may saturate the local energy storage, participating in the sharing process should be considered.

Embodiments make use of Convolution Neural Network (CNN) based federated learning to predict the next-stage energy statistics of the system using aggregation over the smart contract. The blockchain has allows keeping the federated learning model and the calculation of basic federated averaging as presented in the blockchain federated calculation algorithm 500 in which local updates and predictions are performed off-chain.

The blockchain federated calculation algorithm 500 can be initialized with an initial federated learning model, a desired number of nodes (e.g., a number of energy prosumers or consumers), a learning rate, and a number of total rounds. The initial federated learning model can be pushed to the blockchain.

At line 1 of the blockchain federated calculation algorithm 500, a while loop can be initiated. The while loop can check if the current round is less than the desired amount of total rounds.

At line 2 of the blockchain federated calculation algorithm 500, a number of participating nodes (e.g., energy prosumers and/or consumers) equal to the desired number of nodes are selected. The selection may be random, pseudo-random, or based on the stored energy trading data. In embodiments, participating nodes may be energy prosumer computers or energy consumer computers.

At line 3 of the blockchain federated calculation algorithm 500, a loop is initiated to parse through each participating node.

At line 4 of the blockchain federated calculation algorithm 500, the local data of the participating node is retrieved.

At line 5 of the blockchain federated calculation algorithm 500, the participating node retrieves the federated learning model from the blockchain.

At line 6 of the blockchain federated calculation algorithm 500, the participating node retrieves the number of epochs from the blockchain.

At line 7 of the blockchain federated calculation algorithm 500, the participating node computes the local gradient for the retrieved epochs.

At line 8 of the blockchain federated calculation algorithm 500, the participating node can update the federated learning model to include the computed local gradient, according to the learning rate.

At line 9 of the blockchain federated calculation algorithm 500, the participating node can transmit the updated federated learning model to the blockchain.

At line 10 of the blockchain federated calculation algorithm 500, the while loop is broken.

At line 11 of the blockchain federated calculation algorithm 500, the federated average of the federated learning models is computed to form a global federated learning model.

At line 12 of the blockchain federated calculation algorithm 500, a round counter is updated.

Embodiments make use of advantages provided by federated learning. Federated learning reduces the network load that would traditionally be burdened by the server computer 130 of FIG. 1. In conventional machine learning, all training data held by nodes, usually of size in Gigabytes, would be shared with the server computer 130 to perform the functions of the blockchain federated calculation algorithm 500. Such methods cause a huge load on the server computer 130 and have a great impact on its performance. With federated learning, the data is trained locally and only weights of the models, which is on the order of kilobytes, are shared with the server computer 130. The following equations describe the gain in networking load:

$${Load}_{M L} = {\sum }_{i = 1}^{N} {Size}_{i}$$

$${Load}_{FL} = 2 \times {Size}_{mf} \times {N}_{p} \times R$$

Where Load_{ML} represents the network load for conventional machine learning methods and Load_{FL} represents the network load for federated learning. Size; represents the size of data that is received from participant I, Size_{MF} is the size of the federated learning model, Np is the number of participating nodes in a round, and R is the number of rounds performed. The factor of 2 is included for the federated learning network node due to the federated learning model being sent once from the server computer to the node, and back from the node to the computer. The networking gain can then be seen as:

$${Gain}_{FL} = 1 - {Load}_{FL} / {Load}_{ML}$$

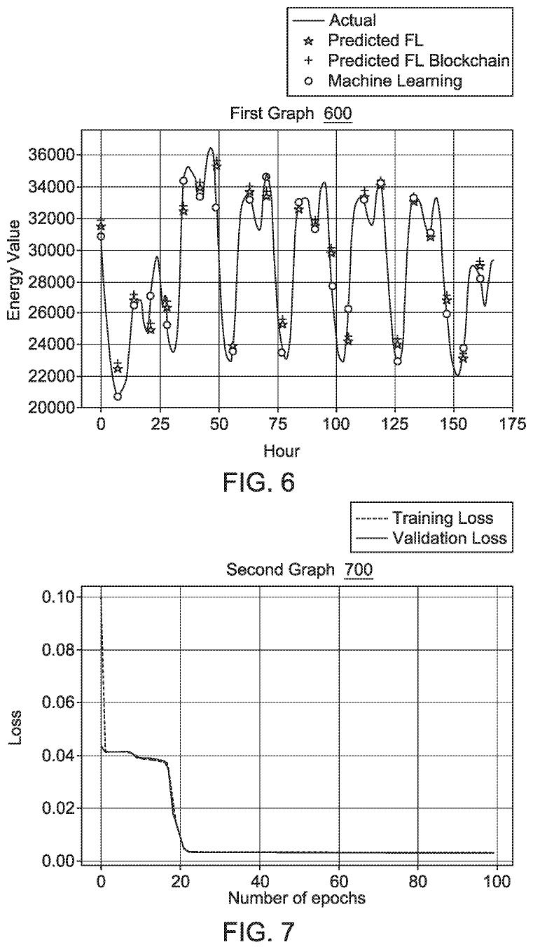

Exemplary results of test conducted using embodiments are described with reference to FIGS. 6-14. The smart contracts described by FIG. 3 are created using Remix IDE1 and implemented on Ethereum using the Ganache framework and a GethThe prototype system based on the following assumptions. 1) All the participants register themselves to the system through the main contract. 2) A participant is either an energy prosumer or an energy consumer in each time step and there is no relationship between the energy prosumers and the energy consumers. 3) An energy consumer is either a able to buy energy or without available resources to cover energy buying requirements. 4) The microgrid-to-microgrid trading cost is defined at the beginning of each time step. 5) The peer-to-peer trading price should be lower than the trading cost between microgrids and lower than the utility price as presented earlier in the disclosure.

All the energy transfers are executed through the blockchain based on the various smart contracts defined above in FIG. 3. In these experiments, the Hourly Energy Consumption dataset, as seen in M. Gržanić, J. M. Morales, S. Pineda, and T. Capuder, “Electricity cost-sharing in energy communities under dynamic pricing and uncertainty,” IEEE Access, pp. 1-1, 2021., containing 4 years of electrical consumption, generation, pricing, and weather data for Spain is used. It contains two major pieces of information needed for the proposed model for each timestamp: the energy generated by reusable energy resources such as wind and solar energy and the data for energy demand. The dataset also involves information related to the weather as it was part of a project from the Open Weather API to study the impact of the weather conditions on renewable energy in the area. The prediction method can, then, used this information to determine future energy consumption and production in the area.

To run the local training, Keras's CNN model was used. The resultant weights are then shared with Ethereum Smart Contracts using the function set model taking the various weights as input. After gathering the N federated learning models, the federated averaging function is initiated to calculate the weight averaging. The global federated learning model is then shared with all participants. To evaluate the federated learning model, RMSE and MAPE are considered. The expressions for RMSE and MAPE are as follows:

$$RMSE = \sqrt{{\sum }_{i = 1}^{{N}_{P}} {( {ya}_{i} - {yp}_{i} )}^{2} / {N}_{P}}$$

$$MAPE = \frac{100 \%}{{N}_{P}} {\sum }_{i = 1}^{{N}_{P}} \vert \frac{{ya}_{i} - {yp}_{i}}{{ya}_{i}} \vert$$

where ypᵢ the represents the predicted value, yaᵢ is the actual value and Np represents the number of predicted values.

To evaluate the predictive mechanism, three types of models are used, the results are summarized by the below Table 1.

| Model | RMSE | MAPE | Epochs |
|---|---|---|---|
| Machine Learning | 0.0116 | 1.39% | 20 |
| Federated Learning | 0.0237 | 2.23% | 100 |
| Federated Learning Blockchain | 0.0332 | 3.34% | 100 |

The values of RMSE and MAPE when models are trained are shown in table 3. For machine learning models 20 epochs were used while 100 epochs per participant were considered for the two federated learning models. Indeed, the decrease in the amount of data increases the need for more epochs to get desired results. In addition, in each round, 5 rounds with 20 nodes were used in federated learning scenarios. The MAPE results show that federated learning performs comparably to machine learning. The MAPE for the blockchain model is high due to errors in handling floating point numbers, hence techniques were used to store weights over Solidity such as multiplication with 232. The prediction results and training/validation loss are shown in FIG. 6 and FIG. 7.

FIG. 6 is an exemplary graph 600 of predicted energy load per hour according to certain embodiments.

FIG. 7 is an exemplary graph 700 of training loss vs. validation loss according to certain embodiments.

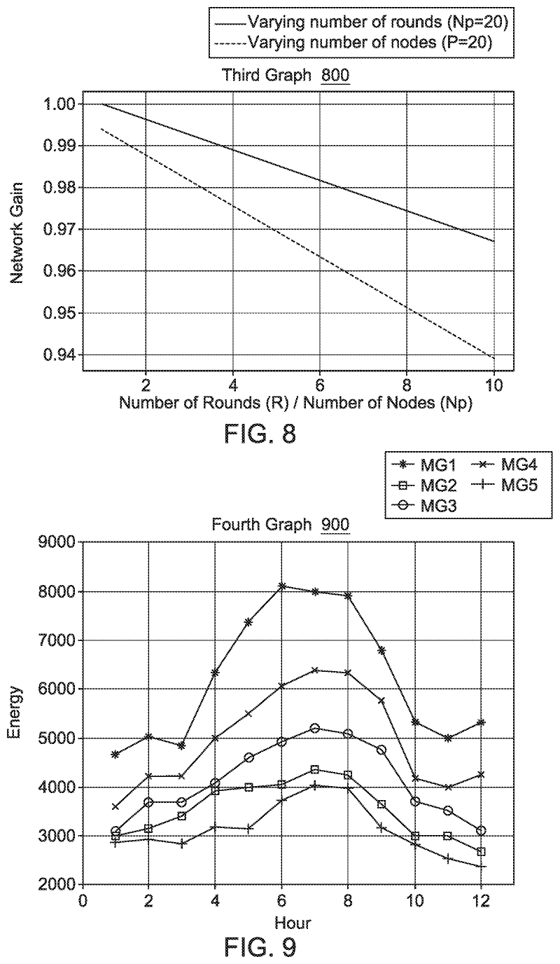

To evaluate the network load gain, the size of the model and the size of data is calculated. The size of the model is 0.312 Kb, and the size of data is 25.6 Mb. The gain is determined using the above-described equation and results are summarized by FIG. 8.

FIG. 8 is an exemplary graph 800 of total network gain achieved according to certain embodiments. As shown in FIG. 8, various values for R and Np were used to understand the effect that the number of rounds and the number of participants on network load. FIG. 8 shows the network gain with (1) variable R values (from 1 to 10) when Np is equal to 20 (the upper curve) and with (2) variable Np values (from 1 to 10) when R is equal to 20 (the lower curve). It can be seen that the impact of the number of rounds over gain is less important than that of the number of participating nodes. The maximum of 99.7% gain was obtained with 1 round containing 5 participants.

The benefits of the energy sharing mechanism is explored in FIGS. 9-14. Due to situations where the energy consumers are not able to purchase energy due to a lack of their funds or otherwise, the energy prosumers can be burdened the cost of storage of unsold energy. In embodiments, the energy consumer can take advantage the sharing phase by receiving some of the energy prosumer's unsold energy. To evaluate the energy sharing mechanism, a system of microgrids grouping a total of 100 energy prosumers and 300 energy consumers is considered. FIG. 9 shows the total energy production in the system.

FIG. 9 is an exemplary graph 900 of energy generation of five microgrids according to certain embodiments. Each connected line describes the energy production of each of the five microgrids per hour.

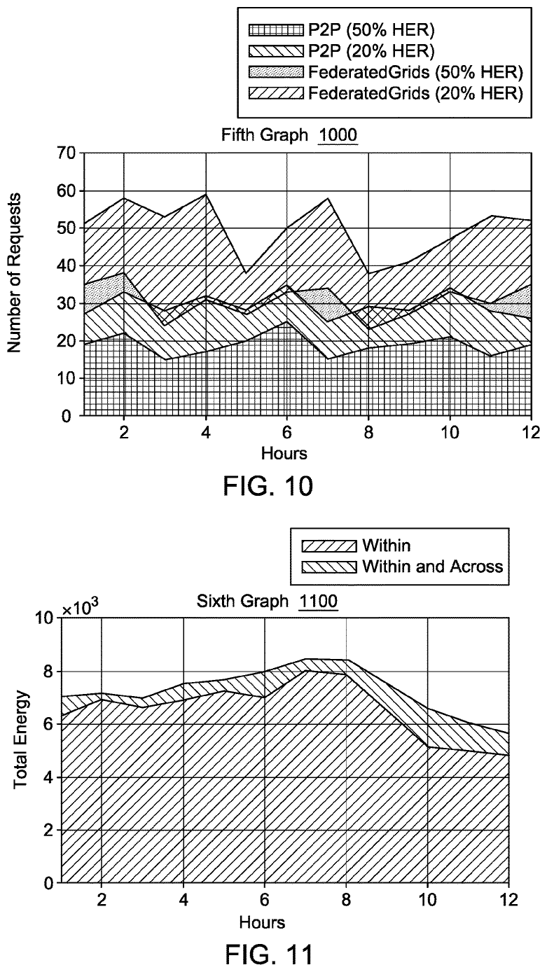

At the end of the trading phase, 100 consumer sharing participation requests are received from energy consumers. As shown in FIG. 10, several requests were completed and many of the energy consumers were able to take advantage of the energy sharing phase.

FIG. 10 is an exemplary graph 1000 of completed energy share requests according to certain embodiments. When a small amount of sharing energy is requested, energy share requests are more likely to be fulfilled. In this embodiment, the P2P energy trading and sharing platform operates using a first come first served basis. As such, if the requested amount of energy sharing is large, it is more likely that the system will run out of excess energy to be shared.

Consumer sharing participation requests are more likely to be completed if the energy is shared within a microgrid and between the microgrids as can be seen in FIG. 11.

FIG. 11 is an exemplary graph 1100 of energy shared within a microgrid and energy shared across microgrids according to certain embodiments. By allowing the sharing of energy across microgrids, a greater amount of energy can be shared.

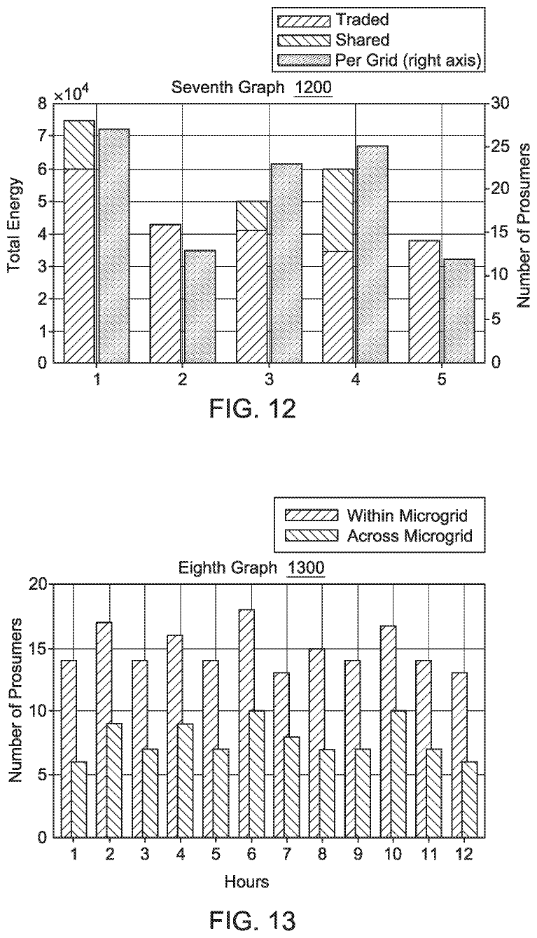

The total energy load includes all energy that is traded and shared and disregards the non-fulfilled consumer sharing participation requests, in each microgrid. The total energy load is of interest, as it represents the energy load, which can be used to generate predictions for the next-stage energy load. The total energy shared and traded is shown in FIG. 12.

FIG. 12 is an exemplary graph 1200 of energy shared and traded by each of five microgrids according to certain embodiments. It can be seen that the second microgrid and the fifth microgrid end the trading phase with no energy left. They are however able benefit from the large amount of excess energy of energy prosumers of the fourth microgrid.

The amount of energy shared within a microgrid depends directly on the number of available energy prosumers during the sharing phase. Again, the P2P energy trading and sharing platform covers local requests inside the microgrid first before sharing the energy with energy consumers of other microgrids. FIG. 13 shows the availability of energy prosumers able to contribute towards sharing.

FIG. 13 is an exemplary graph 1300 of kilowatt-hours of energy shared by energy prosumers within a microgrid and between microgrids according to certain embodiments.

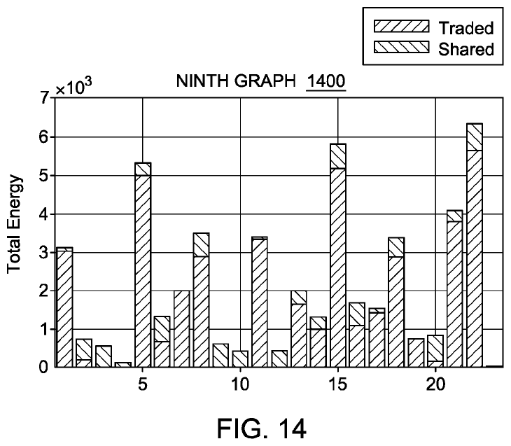

Energy prosumers with the largest energy production in general have the highest contribution in both the trading and sharing phases. FIG. 14 shows the total shared and traded energy for each energy prosumer in the third microgrid.

FIG. 14 is an exemplary graph 1400 of kilowatt-hours of energy traded and shared by per prosumer in a microgrid according to certain embodiments. As expected, the P2P energy sharing and trading platform matches consumer participation requests with energy prosumer with the energy prosumer with the most available energy. Additionally, in some embodiments, the platform can first match consumer participation requests with the highest sharing participation value as a benefit to energy prosumers for participating in the sharing phase.

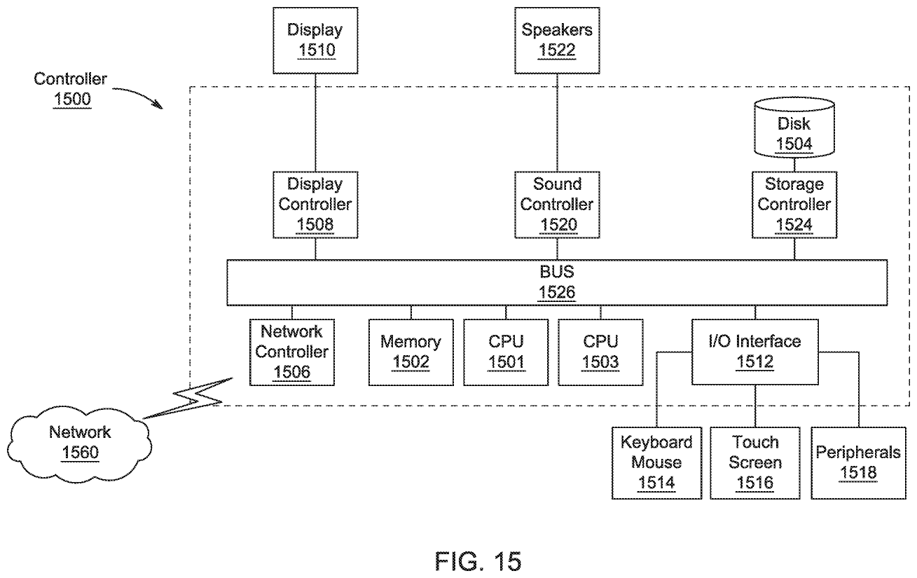

Next, further details of the hardware description of the computing environment according to exemplary embodiments is described with reference to FIG. 15. In FIG. 15, a controller 1500 is described is representative of the previously described computers in which the controller is a computing device which includes a CPU 1501 which performs the processes described above/below. The process data and instructions may be stored in memory 1502. These processes and instructions may also be stored on a storage medium disk 1504 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1501, 1503 and an operating system such as Microsoft Windows 7, Microsoft Windows 10, Microsoft Windows 11, UNIX, Solaris, LINUX, Apple MAC-OS and other systems known to those skilled in the art.

The hardware elements in order to achieve the computing device may be realized by various circuitry elements, known to those skilled in the art. For example, CPU 1501 or CPU 1503 may be a Xenon or Core processor from Intel of America or an Opteron processor from AMD of America, or may be other processor types that would be recognized by one of ordinary skill in the art. Alternatively, the CPU 1501, 1503 may be implemented on an FPGA, ASIC, PLD or using discrete logic circuits, as one of ordinary skill in the art would recognize. Further, CPU 1501, 1503 may be implemented as multiple processors cooperatively working in parallel to perform the instructions of the inventive processes described above.

The computing device in FIG. 15 also includes a network controller 1506, such as an Intel Ethernet PRO network interface card from Intel Corporation of America, for interfacing with network 1560. As can be appreciated, the network 1560 can be a public network, such as the Internet, or a private network such as an LAN or WAN network, or any combination thereof and can also include PSTN or ISDN sub-networks. The network 1560 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1508, such as a NVIDIA GeForce GTX or Quadro graphics adaptor from NVIDIA Corporation of America for interfacing with display 1510, such as a Hewlett Packard HPL2445w LCD monitor. A general purpose I/O interface 1512 interfaces with a keyboard and/or mouse 1514 as well as a touch screen panel 1516 on or separate from display 1510. General purpose I/O interface also connects to a variety of peripherals 1518 including printers and scanners, such as an OfficeJet or DeskJet from Hewlett Packard.

A sound controller 1520 is also provided in the computing device such as Sound Blaster X-Fi Titanium from Creative, to interface with speakers/microphone 1522 thereby providing sounds and/or music.

The general purpose storage controller 1524 connects the storage medium disk 1504 with communication bus 1526, which may be an ISA, EISA, VESA, PCI, or similar, for interconnecting all of the components of the computing device. A description of the general features and functionality of the display 1510, keyboard and/or mouse 1514, as well as the display controller 1508, storage controller 1524, network controller 1506, sound controller 1520, and general purpose I/O interface 1512 is omitted herein for brevity as these features are known.

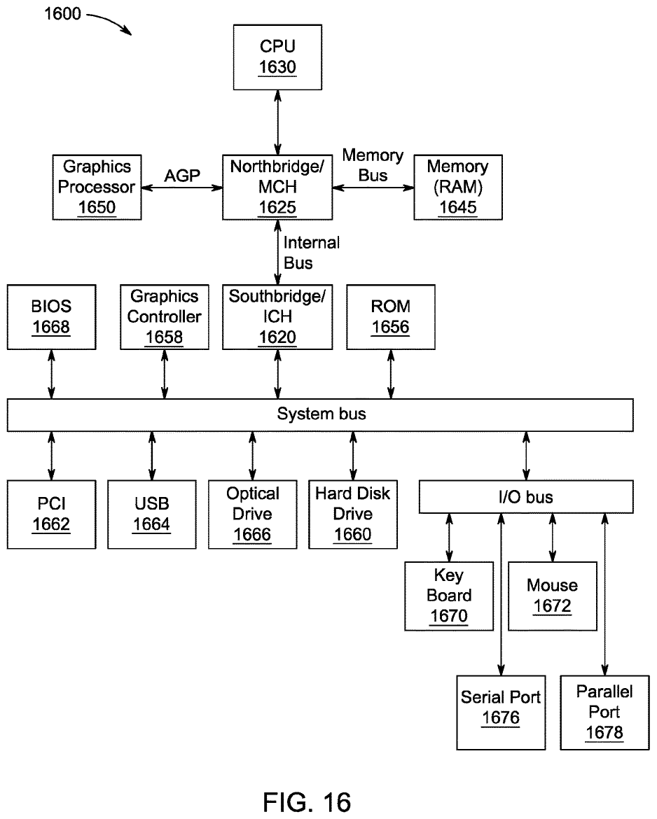

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 16.

FIG. 16 shows a schematic diagram of a data processing system, according to certain embodiments, for performing the functions of the exemplary embodiments. The data processing system is an example of a computer in which code or instructions implementing the processes of the illustrative embodiments may be located.

In FIG. 16, data processing system 1600 employs a hub architecture including a north bridge and memory controller hub (NB/MCH) 1625 and a south bridge and input/output (I/O) controller hub (SB/ICH) 1620. The central processing unit (CPU) 1630 is connected to NB/MCH 1625. The NB/MCH 1625 also connects to the memory 1645 via a memory bus, and connects to the graphics processor 1650 via an accelerated graphics port (AGP). The NB/MCH 1625 also connects to the SB/ICH 1620 via an internal bus (e.g., a unified media interface or a direct media interface). The CPU Processing unit 1630 may contain one or more processors and even may be implemented using one or more heterogeneous processor systems.

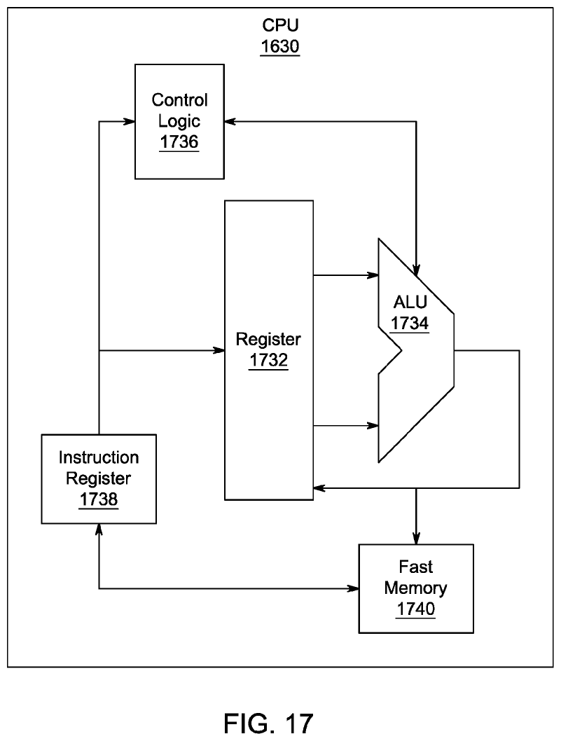

For example, FIG. 17 shows one implementation of the CPU 1630. In one implementation, the instruction register 1738 retrieves instructions from the fast memory 1740. At least part of these instructions are fetched from the instruction register 1738 by the control logic 1736 and interpreted according to the instruction set architecture of the CPU 1630. Part of the instructions can also be directed to the register 1732. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1734 that loads values from the register 1732 and performs logical and mathematical operations on the loaded values according to the instructions. The results from these operations can be feedback into the register and/or stored in the fast memory 1740. According to certain implementations, the instruction set architecture of the CPU 1630 can use a reduced instruction set architecture, a complex instruction set architecture, a vector processor architecture, a very large instruction word architecture. Furthermore, the CPU 1630 can be based on the Von Neuman model or the Harvard model. The CPU 1630 can be a digital signal processor, an FPGA, an ASIC, a PLA, a PLD, or a CPLD. Further, the CPU 1630 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 16, the data processing system 1600 can include that the SB/ICH 1620 is coupled through a system bus to an I/O Bus, a read only memory (ROM) 1656, universal serial bus (USB) port 1664, a flash binary input/output system (BIOS) 1668, and a graphics controller 1658. PCI/PCIe devices can also be coupled to SB/ICH 888 through a PCI bus 1662.

The PCI devices may include, for example, Ethernet adapters, add-in cards, and PC cards for notebook computers. The Hard disk drive 1660 and CD-ROM 1666 can use, for example, an integrated drive electronics (IDE) or serial advanced technology attachment (SATA) interface. In one implementation the I/O bus can include a super I/O (SIO) device.

Further, the hard disk drive (HDD) 1660 and optical drive 1666 can also be coupled to the SB/ICH 1620 through a system bus. In one implementation, a keyboard 1670, a mouse 1672, a parallel port 1678, and a serial port 1676 can be connected to the system bus through the I/O bus. Other peripherals and devices that can be connected to the SB/ICH 1620 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements.

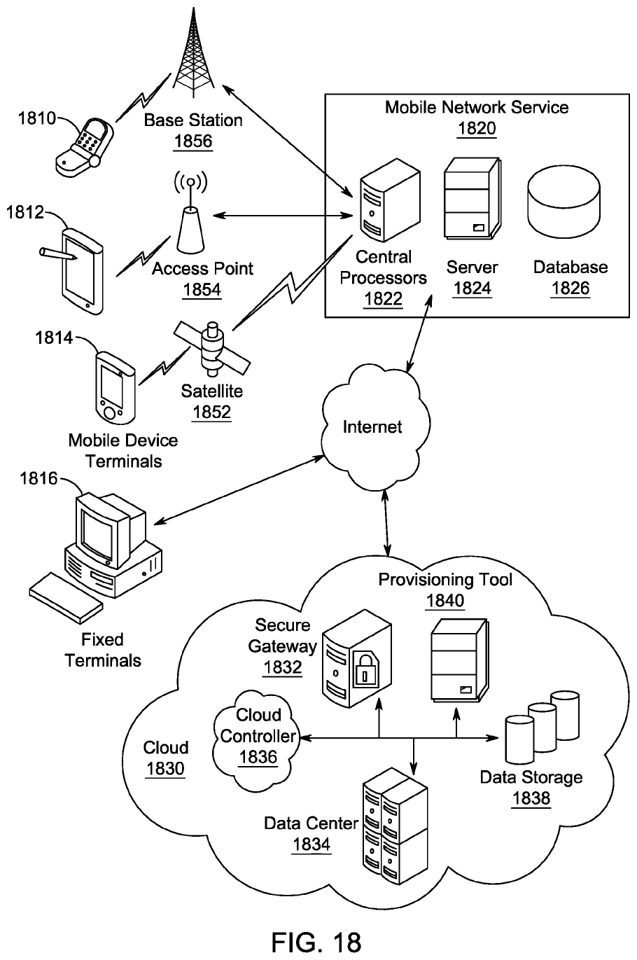

The functions and features described herein may also be executed by various distributed components of a system. For example, one or more processors may execute these system functions, wherein the processors are distributed across multiple components communicating in a network. The distributed components may include one or more client and server machines, which may share processing, as shown by FIG. 18, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

The above-described hardware description is a non-limiting example of corresponding structure for performing the functionality described herein.

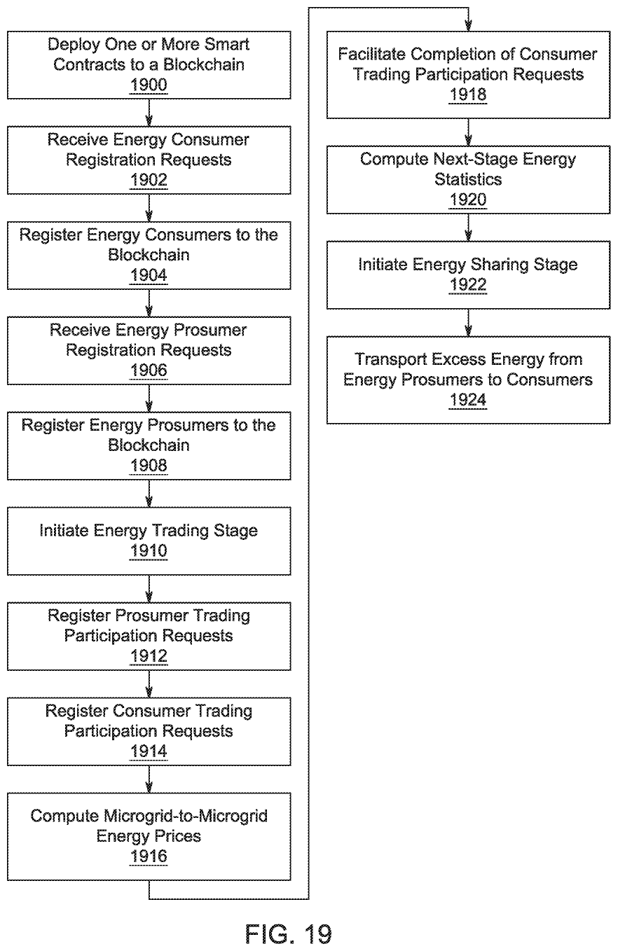

FIG. 19 is an exemplary flowchart for an electrical energy transfer method 1900, according to certain embodiments. The method can be performed by the server computer 130 of FIG. 1. The server computer 130 can operate and maintain the blockchain 132.

At step 1900, the server computer can deploy one or more smart contracts to a blockchain. The one or more smart contracts can include a main smart contract used to register users to the energy blockchain, facilitate participation requests of the energy trading phase and the energy sharing phase, and to compute next-stage energy statistics. Another example of a smart contract can include a peer-to-peer smart contract used to assign, store, and access microgrid identifiers to energy consumers and energy prosumers. Yet another example of a smart contract can include a microgrid-to-microgrid smart contract used to facilitate participation requests involving transfer of energy from a first microgrid to a second microgrid. An additional smart contract can include a peer-to-grid smart contract used to facilitate participation requests involving transfer of energy from a utility grid to a microgrid. The one or more smart contracts can further include a federated learning smart contract used to distribute the federated learning model to energy consumer computers and to energy prosumer computers and to retrieve the computations from the energy consumer computers and the energy prosumer computers. Further details of such smart contracts are described with reference to FIG. 3.

At step 1902, the server computer can receive, from each of a plurality of energy consumer computers, an energy consumer registration request comprising a consumer geographic location indicator. For example, energy consumer computers can use the main smart contract to register themselves to the blockchain. Each of the plurality of energy consumer computers can be operated by an energy consumer associated with the geographic location indicated by the consumer geographic location indicator. For example, as shown in FIG. 1., the first energy consumer 106 can operate a computer and can be associated with a street address of a house.

At step 1904, responsive to receiving an energy consumer registration request, the server computer can register the energy consumer to the blockchain. The registration can include providing the energy consumer with a microgrid identifier that identifies a microgrid that the energy consumer geographic location is proximate to. In some embodiments registration can additionally include generating a unique identifier for the energy consumer. Registration can also include storing the microgrid identifier, the geographic location identifier, and optionally the unique consumer identifier.

At step 1906, the server computer can receive, from each of a plurality of energy prosumer computers, an energy prosumer registration request comprising a prosumer geographic location indicator and an available energy amount. Similar to the energy consumer computers of step 1902, the each of the plurality of energy prosumer computers can be operated by an energy prosumer associated with the geographic location indicated by the prosumer geographic location indicator, such as the first energy prosumer 102 of FIG. 1.

At step 1908, responsive to receiving an energy prosumer registration request, the server computer can register the energy prosumer to the blockchain. The energy prosumer can be given a microgrid identifier that identifies a microgrid that the energy prosumer geographic location is proximate to. The registration can include providing the energy prosumer with a microgrid identifier that identifies a microgrid that the energy prosumer geographic location is proximate to. In some embodiments registration can additionally include generating a unique identifier for the energy prosumer. Registration can also include storing the microgrid identifier, the geographic location identifier, available energy amount, and optionally the unique prosumer identifier.

At step 1910, the server computer can initiate an energy trading stage on the blockchain. The server computer can transmit a notification to the plurality of energy prosumer computers and the plurality of energy consumer computers. Alternatively, the server computer can schedule the opening of the energy trading stage to be at a set time.

At step 1912, the server computer can receive, from one or more of the plurality of energy prosumer computers, a prosumer trading participation request comprising the prosumer geographic location indicator and the available energy amount of the energy prosumer. For example, the energy prosumer computer can use the main smart contract of the blockchain to transmit the prosumer trading participation request.

At step 1914, the server computer can receive, from one or more of the plurality of consumer energy computers, a consumer trading participation request comprising the consumer geographic location indicator and a requested energy amount of the energy consumer. For example, the energy consumer computer can use the main smart contract of the blockchain to transmit the consumer trading participation request.

From blocks 1916-1918, the server computer can parse through each microgrid of the plurality of microgrids.

At step 1916, the server computer can compute an energy price for trading between the current microgrid and each of the other microgrids in the plurality of microgrids. The energy price can follow that energy trading within a microgrid is less than energy trading between microgrids which is less than energy trading with a utility grid.

At step 1918, the server computer can facilitate the consumer trading participation requests received from energy consumers in the microgrid using the blockchain. For example, the energy request processing algorithm 400 as described in FIG. 4 of the main smart contract can be used. The server computer can match the energy consumer trading participation request first to energy prosumers within the microgrid of the energy consumer. If the local energy supply is unable to fulfill the consumer trading participation request, then the server computer can match the energy consumer to an energy prosumer of a different microgrid. If the system energy supply is still unable to fulfill the consumer trading participation request, the server computer can allow the energy consumer to complete their request with a utility grid.

At step 1920, the server computer can compute next-stage energy statistics using a federated learning model distributed to one or more energy consumer computers or energy prosumer computers. The next stage energy statistics can include a predicted energy generation of energy prosumers in each microgrid of the plurality of microgrids, a predicted energy load of each individual energy consumer in each microgrid of the plurality of microgrids, a predicted amount of energy transferred in the next energy trading stage and the next energy sharing stage, and a predicted cost of energy in the next energy trading stage. The server computer can employ federated learning to more efficiently compute the next-stage energy statistics. The server computer can provide a federated learning model to the blockchain which can be transmitted to participants of the blockchain. The participants can locally generate weights for the federated learning model and transmit the federated learning model with updated weights back to the blockchain. Federated averaging can then be used by the server computer to generate the global federated learning model and then the server computer can generate next-stage energy statistics. An example algorithm is described by the blockchain federated calculation algorithm 500 of FIG. 5.

At step 1922, the server computer can initiate an energy sharing stage on the blockchain. The server computer can determine if the energy sharing stage is to be held based on the next-stage energy statistics. For example, if the predicted energy load of the next-stage is larger than the predicted energy production, then the server computer can choose to not initiate the energy sharing stage.

At step 1924, the server computer can facilitate the transport of excess available energy from one energy prosumer in a first microgrid to either an energy consumer in the first microgrid or an energy storage unit of a second microgrid. The server computer can process consumer sharing participation requests in a similar manner to how it processes consumer trading participation requests. An exemplary algorithm is described by the energy request processing algorithm 400 of FIG. 4.

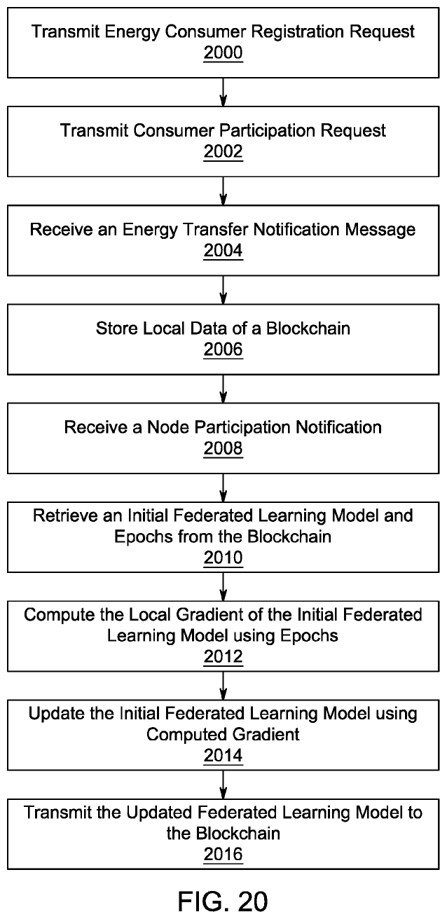

FIG. 20 is an exemplary flowchart for another electrical energy transfer method, according to certain embodiments. The method can be performed by an energy consumer of FIG. 1.

At step 2000, the energy consumer computer can transmit an energy consumer registration request comprising a geographic location indicator to a blockchain operated by a server computer. The energy consumer computer can transmit the energy consumer registration request using the main smart contract 300 of FIG. 3. In some embodiments, the registration request can result in the blockchain providing a unique consumer identifier to the energy consumer computer.

At step 2002, the energy consumer computer can transmit a consumer participation request comprising a requested energy amount and a request type to the blockchain. The request type can be “trading” or “sharing” dependent on the phase the energy consumer wishes to participate in. The energy consumer computer can use the main smart contract 300 of FIG. 3 to transmit the consumer participation request. In response to receiving the consumer participation request, the blockchain can thereafter facilitates completion of the consumer participation request as described by the energy request processing algorithm 400 of FIG. 4.

At step 2004, the energy consumer computer can receive an energy transfer notification message. The energy transfer notification message can include instructions to complete a financial transaction with one or more energy prosumers in order to initiate the transport of electrical energy from the energy prosumer to the energy consumer.

At step 2006, the energy consumer computer can store local data of the blockchain in memory.

At step 2008, the energy consumer computer can receive a node participation notification from the server computer. The node participation notification can notify the energy consumer computer that it will act as a node in the blockchain-based federated calculation algorithm 500 of FIG. 5.

At step 2010, responsive to receiving the node participation notification, the energy consumer computer can retrieve an initial federated learning model and one or more epochs from the blockchain. The initial federated learning model can include a convolutional neural network.

At step 2012, the energy consumer computer can compute the local gradient of the initial federated learning model for the retrieved epochs.

At step 2014, the energy consumer computer can update the initial federated learning model using the computed gradients to generate an updated federated learning model.

At step 2016, the energy consumer computer can transmit the updated federated learning model to the server computer. The server computer can then use the updated federated learning model to generate a global federate learning model by combining it, using federated averaging, with a plurality of updated federated learning models received from a plurality of energy consumer computers.

Numerous modifications and variations of the present disclosure are possible in light of the above teachings. It is therefore to be understood that within the scope of the appended claims, the invention may be practiced otherwise than as specifically described herein.

1. An electrical energy transfer method facilitated by a server computer, the method comprising:
deploying, by the server computer, one or more smart contracts to a blockchain;
receiving, by the server computer from each of a plurality of energy consumer computers, an energy consumer registration request comprising a consumer geographic location indicator, wherein each of the plurality of energy consumer computers is operated by an energy consumer associated with the geographic location indicated by the consumer geographic location indicator;
responsive to receiving an energy consumer registration request, registering, by the server computer, the energy consumer to the blockchain, wherein the energy consumer is given a microgrid identifier that identifies a microgrid that the energy consumer geographic location is proximate to;
receiving, by the server computer from each of a plurality of energy prosumer computers, an energy prosumer registration request comprising a prosumer geographic location indicator and an available energy amount, wherein each of the plurality of energy prosumer computers is operated by an energy prosumer associated with the geographic location indicated by the prosumer geographic location indicator;
responsive to receiving an energy prosumer registration request, registering, by the server computer, the energy prosumer to the blockchain, wherein the energy prosumer is given a microgrid identifier that identifies a microgrid that the energy prosumer geographic location is proximate to;
initiating, by the server computer, an energy trading stage on the blockchain;
receiving, by the server computer from one or more of the plurality of energy prosumer computers, a prosumer trading participation request comprising the prosumer geographic location indicator and the available energy amount of the energy prosumer;
receiving, by the server computer from one or more of the plurality of consumer energy computers, a consumer trading participation request comprising the consumer geographic location indicator and a requested energy amount of the energy consumer;
for each microgrid of the plurality of microgrids:
computing, by the server computer, an energy price for trading between the current microgrid and each of the other microgrids in the plurality of microgrids;
facilitating, by the server computer, the consumer trading participation requests received from energy consumers in the microgrid using the blockchain;
computing, by the server computer, next-stage energy statistics using a federated learning model distributed to one or more energy consumer computers or energy prosumer computers;
initiating, by the server computer, an energy sharing stage on the blockchain; and
facilitating, by the server computer, the transport of excess available energy from one energy prosumer in a first microgrid to either an energy consumer in the first microgrid or an energy storage unit of a second microgrid.

2. The method of claim 1, wherein the one or more smart contract comprise at least:
a main smart contract used to register users to the blockchain, facilitate participation requests of the energy trading phase and the energy sharing phase, and to compute next-stage energy statistics;
a peer-to-peer smart contract used to assign, store, and access microgrid identifiers to energy consumers and energy prosumers;
a microgrid-to-microgrid smart contract used to facilitate participation requests involving transport of energy from a first microgrid to a second microgrid;
a peer-to-grid smart contract used to facilitate participation requests involving transport of energy from a utility grid to a microgrid; and
a federated learning smart contract used to distribute the federated learning model to energy consumer computers and to energy prosumer computers and to retrieve the computations from the energy consumer computers and the energy prosumer computers.

3. The method of claim 1, wherein the energy consumer registration request further comprises an expected energy demand, wherein the expected energy demand is input into the federated learning model to predict the total load of the microgrid that is proximate to the consumer's associated geographic located.

4. The method of claim 1, wherein registering the energy consumer to the blockchain comprises generating, by the server computer, a unique consumer identifier for the energy consumer and storing the unique consumer identifier, the geographic location indicator of the energy consumer, and the microgrid identifier of the energy consumer and wherein registering the energy prosumer to the blockchain comprises generating a unique prosumer identifier for the energy prosumer and storing the unique prosumer identifier, the geographic location indicator of the energy prosumer, the available energy amount, and the microgrid identifier of the energy prosumer.

5. The method of claim 1, wherein facilitating the consumer trading participation requests received from energy consumers in the microgrid using the blockchain comprises:
matching, by the server computer, an energy consumer in the microgrid to an energy prosumer in the microgrid using a smart contract deployed on the blockchain; and
transferring, by the server computer, a value amount from a consumer account associated with the energy consumer to a prosumer account associated with the energy prosumer, wherein after the value amount is transferred from the consumer account to the prosumer account, the requested energy amount is transported from the energy prosumer to the energy consumer.

6. The method of claim 1, wherein the available energy amount from energy prosumers in a microgrid is less than the requested energy amount from energy consumers in the microgrid.

7. The method of claim 6, wherein facilitating the consumer trading participation requests received from energy consumers in the microgrid using the blockchain comprises:
matching, by the server computer, an energy consumer in the current microgrid to an energy prosumer in a second microgrid, wherein the second microgrid is proximate to the current microgrid; and
transferring, by the server computer, a value amount from a consumer account associated with the energy consumer to a prosumer account associated with the energy prosumer, wherein after the value amount is transferred from the consumer account to the prosumer account, the requested energy amount is transported from the energy prosumer to the energy consumer.

8. The method of claim 6, wherein facilitating the consumer trading participation requests received from energy consumers in the microgrid using the blockchain comprises:
transferring, by the server computer, a value amount from a consumer account associated with the energy consumer to a utility account associated with a utility grid, wherein after the value amount is transferred from the consumer account to the utility account, the requested energy amount is transported from the utility grid to the energy consumer.

9. The method of claim 1, wherein the next-stage energy statistics include a predicted energy generation of energy prosumers in each microgrid of the plurality of microgrids, a predicted energy load of each individual energy consumer in each microgrid of the plurality of microgrids, a predicted amount of energy transported in the next energy trading stage and the next energy sharing stage, and a predicted cost of energy in the next energy trading stage.

10. The method of claim 1, wherein the federated learning model comprises a convolutional neural network.

11. The method of claim 1, wherein each of the plurality of microgrids are connected to one or more utility grids that are further connected to the energy consumers and the energy prosumers.

12. The method of claim 1, wherein the energy price for trading between the microgrids is less than an energy price for trading inside the microgrid.

13. The method of claim 1, wherein at the energy consumers and the energy prosumers are associated with an energy storage unit that stores transported energy.

14. The method of claim 13, wherein the server computer facilitates the transport of excess available energy from an energy prosumer in a first microgrid to an energy storage unit of energy consumer in the first microgrid, and wherein the energy consumer returns the excess available energy back to the energy prosumer before the next energy trading stage.

15. A non-transitory computer readable medium having instructions stored therein that, when executed by one or more processors, cause the one or more processors to perform a method including:
deploying one or more smart contracts to a blockchain;
receiving, from each of a plurality of energy consumer computers, an energy consumer registration request comprising a consumer geographic location indicator, wherein each of the plurality of energy consumer computers is operated by an energy consumer associated with the geographic location indicated by the consumer geographic location indicator;
responsive to receiving an energy consumer registration request, registering, the energy consumer to the blockchain, wherein the energy consumer is given a microgrid identifier that identifies a microgrid that the energy consumer geographic location is proximate to;
receiving, from each of a plurality of energy prosumer computers, an energy prosumer registration request comprising a prosumer geographic location indicator and an available energy amount, wherein each of the plurality of energy prosumer computers is operated by an energy prosumer associated with the geographic location indicated by the prosumer geographic location indicator;
responsive to receiving an energy prosumer registration request, registering, the energy prosumer to the blockchain, wherein the energy prosumer is given a microgrid identifier that identifies a microgrid that the energy prosumer geographic location is proximate to;
initiating an energy trading stage on the blockchain;
receiving, from one or more of the plurality of energy prosumer computers, a prosumer trading participation request comprising the prosumer geographic location indicator and the available energy amount of the energy prosumer;
receiving, from one or more of the plurality of consumer energy computers, a consumer trading participation request comprising the consumer geographic location indicator and a requested energy amount of the energy consumer;
for each microgrid of the plurality of microgrids:
computing an energy price for trading between the current microgrid and each of the other microgrids in the plurality of microgrids;
facilitating the consumer trading participation requests received from energy consumers in the microgrid using the blockchain;
computing next-stage energy statistics using a federated learning model distributed to one or more energy consumer computers or energy prosumer computers;
initiating an energy sharing stage on the blockchain; and
facilitating the transport of excess available energy from one energy prosumer in a first microgrid to either an energy consumer in the first microgrid or an energy storage unit of a second microgrid.

16. A method comprising:
transmitting, by an energy consumer computer via a smart contract deployed on a blockchain, an energy consumer registration request comprising a geographic location indicator and a request type to the blockchain, wherein the blockchain is operated by a server computer;
transmitting, by the energy consumer computer to the blockchain, a consumer participation request comprising a requested energy amount, wherein the blockchain thereafter facilitates completion of the consumer participation request;
receiving, by the energy consumer computer from the blockchain, an energy transfer notification message; and
storing, by the energy consumer computer, local data of the blockchain.

17. The method of claim 16, further comprising:
receiving, by the energy consumer computer from the server computer, a node participation notification message;
responsive to receiving the node participation notification, retrieving, by the energy consumer computer, an initial federated learning model and one or more epochs from the blockchain;
computing, by the energy consumer computer, a local gradient of the initial federated learning model for the retrieved epochs;
updating, by the energy consumer computer, the initial federated learning model using the computed gradients to generate an updated federated learning model; and
transmitting, by the energy consumer computer to the server computer, the updated federated learning model.

18. The method of claim 17, wherein the server computer uses combines updated federated learning model with one or more different federated learning models using federated averaging to generate a global federated model.

19. The method of claim 16, wherein the consumer participation request is transmitted to the blockchain using a smart contract deployed on the blockchain.

20. The method of claim 16, wherein the request type is a sharing type, and wherein the blockchain facilitates completion of the consumer participation request by transferring the requested energy amount from an energy prosumer to the energy consumer.
